(19) United States
(12) Patent Application Publication
(10) Pub. No.: US 2020/0116088 A1
(43) Pub. Date: Apr. 16, 2020

(54) METHOD FOR CONTROLLING COMBUSTION IN DIESEL ENGINE

(71) Applicants: HYUNDAI MOTOR COMPANY, Seoul (KR); KIA MOTORS CORPORATION, Seoul (KR)

(72) Inventors: Joon Kyu LEE, Yongin-si (KR); Myung Jun LEE, Suwon-si (KR); Soo Hong LEE, Seoul (KR)

(73) Assignees: HYUNDAI MOTOR COMPANY, Seoul (KR); KIA MOTORS CORPORATION, Seoul (KR)

(21) Appl. No.: 16/414,314

(22) Filed: May 16, 2019

(30) Foreign Application Priority Data
Oct. 15, 2018 (KR) 10-2018-0122593

(51) Int. Cl. F02D 19/06; F02D 19/08

(52) U.S. Cl. CPC F02D 19/0602; F02D 19/0663; F02D 19/082

(57) ABSTRACT

A method for controlling combustion in a diesel engine includes: premixing ambient air, EGR gas and vaporized diesel fuel in a combustion chamber during an intake stroke of each cylinder of the diesel engine; and sequentially performing, by an injector, pilot injection, main injection, and post injection during a compression stroke occurs after the intake stroke.

### CROSS-REFERENCE TO RELATED APPLICATION

This application claims priority to and the benefit of Korean Patent Application No. 10-2018-0122593, filed on Oct. 15, 2018, the entire contents of which are incorporated herein by reference.

### FIELD

The present disclosure relates to a method for controlling combustion in a diesel engine.

### BACKGROUND

The statements in this section merely provide background information related to the present disclosure and may not constitute prior art.

A diesel engine injects a fuel into a combustion chamber with high pressure and high temperature at around the top dead center of the compression stroke of the cylinder, so that the fuel is burned by its self-ignition.

Generally, the combustion of the diesel engine is divided into diffusion combustion, premixed combustion, or homogeneous charge compression ignition (HCCI).

In the diffusion combustion of the diesel engine, when air and EGR (Exhaust Gas Recirculation) gas are sucked into the cylinder of the engine in the intake stroke, the fuel is injected into the cylinder during the initial part of the compression stroke, and the injected fuel is atomized into small droplets and vaporized to form an air-fuel mixture. As a piston continues to rise and move closer to a cylinder head, the mixture temperature increases so that auto-ignition occurs. At this time, the diffusion combustion, in which the air-fuel mixing and combustion simultaneously occur, takes place. Emissions are produced as a byproduct of the diffusion combustion process. In the diffusion combustion process, chemical energy of the fuel is converted into thermal energy so that heat is released. Then, in a process that converts it into mechanical energy, engine performance is calculated, and fuel consumption is calculated by the quantity of fuel consumed and the engine performance.

The diffusion combustion of the diesel engine has disadvantages of lowering purification efficiency of soot, reducing fuel efficiency, and increasing combustion noise.

In the premixed combustion of the diesel engine, after air and EGR gas are sucked into the cylinder of the engine in the intake stroke, the fuel is injected into the cylinder at the end of the compression stroke, and the injected fuel is atomized into small droplets and vaporized to form an air-fuel mixture. As the piston continues to rise and move closer to the cylinder head, the mixture temperature increases so that auto-ignition occurs. At this time, the premixed combustion, in which the combustion occurs after the air-fuel mixing, takes place. Emissions are produced as a byproduct of the premixed combustion process, and the premixed combustion process has the effect of reducing soot formation as the combustion occurs after the air-fuel mixing. During the premixed combustion process, chemical energy of the fuel is converted into thermal energy and heat is released. Then, in a process that converts it into mechanical energy, engine performance is calculated, and fuel consumption is calculated based on the quantity of fuel consumed and the engine performance.

We have discovered that the premixed combustion of the diesel engine has the advantage of mitigating soot formation, but has disadvantages of causing unstable combustion since it is difficult to control combustion, and increasing combustion noise due to rapid combustion.

The above information described in this background section is provided to assist in understanding the background of the inventive concept, and may include any technical concept which is not considered as the prior art that is already known to those skilled in the art.

### SUMMARY

The present disclosure has been made to solve the above-mentioned problems occurring in the prior art while advantages achieved by the prior art are maintained intact.

An aspect of the present disclosure provides a method for controlling combustion in a diesel engine by allowing premixed combustion and diffusion combustion to take place simultaneously, thereby achieving premixed and diffusion harmonized combustion.

According to an aspect of the present disclosure, a method for controlling combustion in a diesel engine may include: premixing ambient air, exhaust gas recirculation (EGR) gas, and vaporized diesel fuel in a combustion chamber of the diesel engine during an intake stroke of each cylinder of the diesel engine; and sequentially performing, by an injector, pilot injection, main injection, and post injection during a compression stroke which occurs after the intake stroke.

The main injection may be performed at the end of the compression stroke.

The main injection may be performed in a range from approximately 1.0° degree before top dead center (BTDC) to 1.0° degree after top dead center (ATDC).

A premixed quantity of diesel fuel introduced into the combustion chamber during the intake stroke may account for approximately from 25% to 35% of a total fuel quantity which is supplied per cycle of each cylinder.

A premixed quantity of diesel fuel introduced into the combustion chamber during the intake stroke may account for approximately 30% of a total fuel quantity which is supplied per cycle of each cylinder.

The pilot injection may be performed in a range of from 1100 μs to 1200 μs before starting the main injection, and a pilot injection quantity in the pilot injection may be 1-2 mg.

The post injection may be performed in a range of 300-400 μs after the end of the main injection, and a post injection quantity in the post injection may be from approximately 1 mg to 2 mg.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates the configuration of a diesel engine according to an exemplary form of the present disclosure;

FIG. 2 illustrates a flowchart of a method for controlling combustion in a diesel engine according to an exemplary form of the present disclosure;

FIG. 3 illustrates an intake stroke in a diesel engine according to an exemplary form of the present disclosure;

FIG. 4 illustrates an intake stroke in a diesel engine according to another exemplary form of the present disclosure;

FIG. 5 illustrates a compression stroke in a diesel engine according to an exemplary form of the present disclosure;

FIG. 6 illustrates a power stroke in a diesel engine according to an exemplary form of the present disclosure;

FIG. 7 illustrates an exhaust stroke in a diesel engine according to an exemplary form of the present disclosure;

FIG. 8 illustrates a graph of cases for design of experiments (DOE) analysis with respect to the premixed quantity of diesel fuel for premixing of diesel fuel and ambient air, and Start of Injection (SOI) which is a mapping control factor;

FIG. 9 illustrates a graph of fuel injection velocity according to crank angle degrees in cases in which the premixed quantity of diesel fuel is 0 mg and 2 mg;

FIG. 10 illustrates a graph of brake specific fuel consumption (BSFC) depending on the premixed quantity of diesel fuel;

FIG. 11 illustrates a graph of soot formation rate depending on the premixed quantity of diesel fuel;

FIG. 12 illustrates a graph of a ratio of BSFC with respect to NOₓ production depending on the premixed quantity of diesel fuel;

FIG. 13 illustrates a graph of a ratio of soot with respect to NOₓ production depending on the premixed quantity of diesel fuel;

FIG. 14 illustrates a graph of a ratio of combustion noise level (CNL) with respect to NOₓ production depending on the premixed quantity of diesel fuel;

FIG. 15A illustrates graphs of heat release rates with respect to crank angle degrees depending on the premixed quantity of diesel fuel;

FIGS. 15B to 15D respectively illustrate temperature regions according to exemplary crank angles when the premixed quantity of diesel fuel is 6 mg;

FIGS. 15E to 15G respectively illustrate temperature regions according to exemplary crank angles when the premixed quantity of diesel fuel is 0 mg;

FIG. 16 illustrates a graph of combustion pressure with respect to crank angle degree depending on the premixed quantity of diesel fuel; and

FIG. 17A illustrates graphs of soot formation rates with respect to crank angle degree depending on the premixed quantity of diesel fuel;

FIG. 17B to 17D respectively illustrate soot formation regions according to exemplary crank angles when the premixed quantity of diesel fuel is 6 mg; and

FIGS. 17E to 17G respectively illustrate soot formation regions according to exemplary crank angles when the premixed quantity of diesel fuel is 0 mg.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, a detailed description of well-known techniques associated with the present disclosure will be ruled out in order not to unnecessarily obscure the gist of the present disclosure.

Terms such as first, second, A, B, (a), and (b) may be used to describe the elements in exemplary forms of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

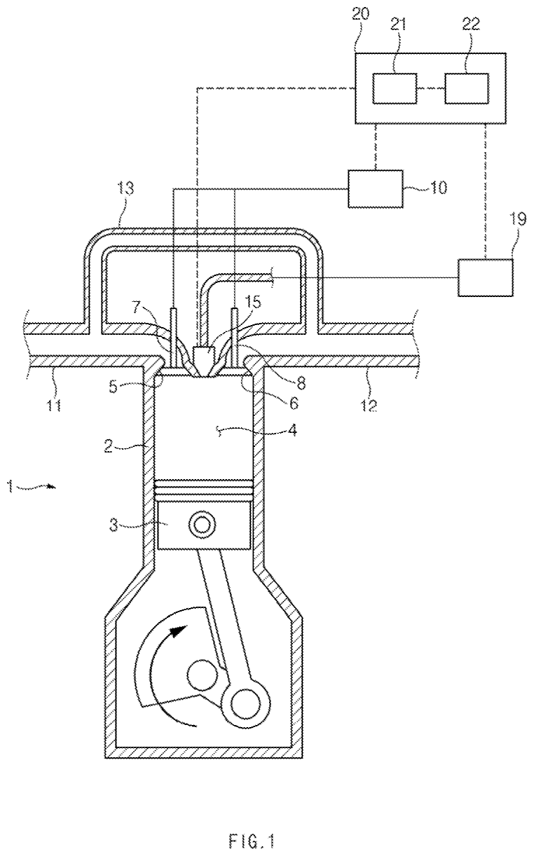

Referring to FIG. 1, a diesel engine 1 according to an exemplary form of the present disclosure may include a plurality of cylinders 2. Only one cylinder is illustrated in FIG. 1 for the convenience of explanation.

A piston 3 may be arranged to reciprocally move in a vertical direction within each cylinder 2. The piston 3 may define a combustion chamber 4 within each cylinder 2. A fuel injector 15 may be mounted to inject a liquid diesel fuel such as light oil into the combustion chamber 4 of each cylinder 2. The fuel injector 15 may be connected to a fuel supply system 19, and the fuel supply system 19 may supply the high-pressure diesel fuel to the fuel injector 15.

Each cylinder 2 may have an intake port 5 and an exhaust port 6 communicating with the combustion chamber 4. The intake port 5 may communicate with an intake pipe 11, and the exhaust port 6 may communicate with an exhaust pipe 12. An inlet of an EGR pipe 13 may be connected to the exhaust pipe 12, and an outlet of the EGR pipe 13 may be connected to the intake pipe 11. An EGR valve, an EGR cooler, and the like may be provided on the EGR pipe 13. EGR gas may be recirculated to the intake port 5 of each cylinder 2.

An intake valve 7 may open or close the intake port 5, and an exhaust valve 8 may open or close the exhaust port 6.

The intake valve 7 and the exhaust valve 8 may be controlled by a variable valve timing mechanism 10 so that the opening/closing timing, opening/closing rate, opening/closing duration, and the like thereof may be adjusted.

An electronic control unit or engine control unit (ECU) 20 may be configured to control the fuel supply system 19, the fuel injector 15, and the variable valve timing mechanism 10. The ECU 20 may include a processor 21 and a memory 22. The processor 21 may be programmed to receive instructions stored in the memory 22 and to send instructions to the fuel supply system 19, the fuel injector 15, and the variable valve timing mechanism 10. The memory 22 may be a data store, such as a hard disk drive, a solid state drive, a server, a volatile storage medium, or a non-volatile storage medium.

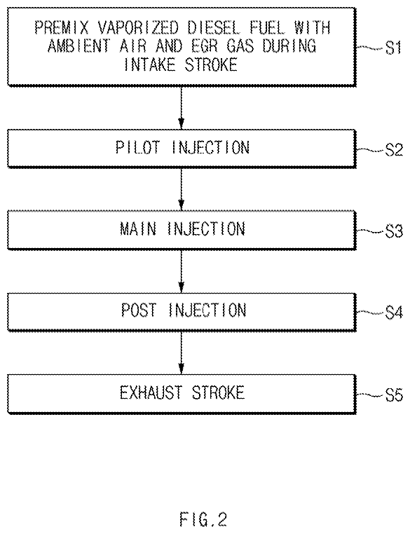

FIG. 2 illustrates a flowchart of a method for controlling combustion in a diesel engine according to an exemplary form of the present disclosure.

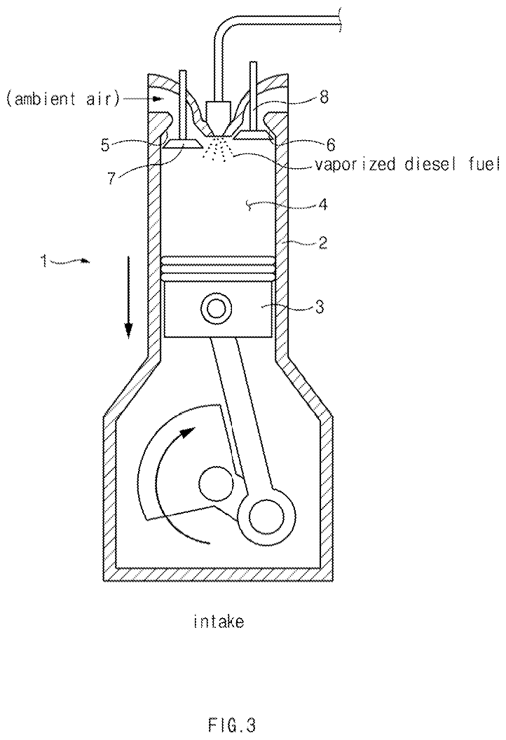

As illustrated in FIG. 3, as the intake valve 7 opens the intake port 5, ambient air and EGR gas may be sucked from the intake port 5 into the combustion chamber 4 so that the intake stroke of each cylinder 2 may occur. According to exemplary forms of the present disclosure, vaporized diesel fuel may be introduced together with the ambient air and EGR gas into the combustion chamber 4 during the intake stroke so that the vaporized diesel fuel may be premixed with the ambient air and EGR gas in the combustion chamber 4 during the intake stroke in operation S1.

According to an exemplary form, as illustrated in FIG. 3, during the intake stroke, the fuel injector 15 may inject a predetermined premixed quantity of diesel fuel into the combustion chamber 4 under control of the ECU 20, and the exhaust valve 8 may open the exhaust port 6 for a predetermined period of time under control of the ECU 20 so that part of emissions may flow back from the exhaust port 6 into the combustion chamber 4, and the liquid diesel fuel injected by the fuel injector 15 may be vaporized by heat from the emissions. Thus, during the intake stroke, the vaporized diesel fuel may be premixed with the ambient air and EGR gas. Here, the degree of opening of the exhaust valve 8 in the intake stroke may be less than that of the exhaust valve 8 in the exhaust stroke, thereby reducing or minimizing any effect on the suction of the ambient air and EGR gas.

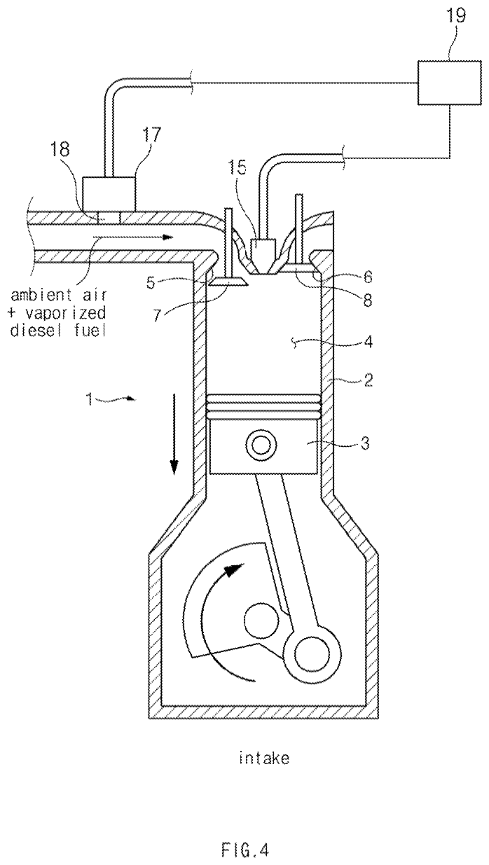

According to another exemplary form, as illustrated in FIG. 4, a heater 17 and a solenoid shut-off valve 18 may be provided on the intake pipe 11, and the heater 17 may be connected to the fuel supply system 19 so that the liquid diesel fuel supplied from the fuel supply system 19 may be vaporized by the heater 17. As the solenoid shut-off valve 18 is opened by the ECU 20 in the intake stroke, the vaporized diesel fuel may be supplied to the intake pipe 11 so that the vaporized diesel fuel, the ambient air, and EGR gas may be sucked into the combustion chamber 4 through the intake pipe 11, and the vaporized diesel fuel may be premixed with the ambient air and EGR gas in the combustion chamber 4 during the intake stroke. The ECU 20 may control the heater 17 to operate for a predetermined period of time before the intake stroke, thereby pre-vaporizing the liquid diesel fuel supplied from the fuel supply system 19. The ECU 20 may control the solenoid shut-off valve 18 to open during the intake stroke, thereby allowing the vaporized diesel fuel to be sucked together with the ambient air and EGR gas into the combustion chamber 4 through the intake pipe 11.

The quantity of diesel fuel introduced into the combustion chamber 4 during the intake stroke, that is, the quantity of diesel fuel premixed with the ambient air and EGR gas in the combustion chamber 4 during the intake stroke may account for from 25% to 35% (diesel fuel premixed ratio) of the total fuel quantity which is supplied per cycle of each cylinder 2, and the quantity of diesel fuel directly injected into the combustion chamber 4 during the compression stroke may account for from 65% to 75% of the total fuel quantity which is supplied per cycle of each cylinder 2. In other words, a ratio of the premixed quantity of diesel fuel introduced during the intake stroke and the quantity of diesel fuel injected during the compression stroke may be in a range from 25:75 to 35:65. As illustrated in FIG. 2, as the diesel fuel is premixed with the ambient air and EGR gas during the intake stroke, premixed combustion may take place before main injection S3.

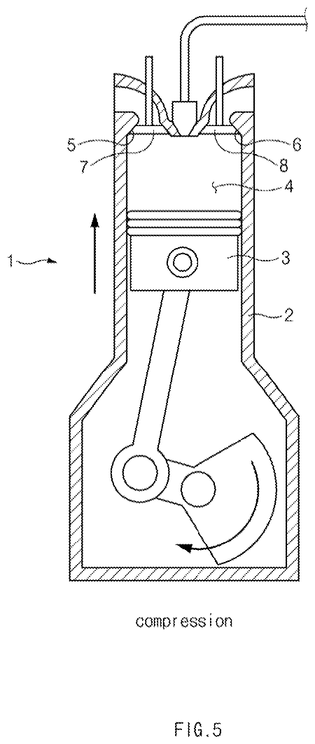

As the piston 3 rises after the intake stroke, the compression stroke may occur as illustrated in FIG. 5. During the compression stroke, pilot injection S2, the main injection S3, and post injection S4 may be sequentially performed by the fuel injector 15.

The pilot injection S2 may be performed during the initial part of the compression stroke, and the fuel injector 15 may inject a predetermined pilot injection quantity of diesel fuel into the combustion chamber 4. For example, the pilot injection S2 may be performed in a range of 1100-1200 μs before the start of the main injection S3, and the pilot injection quantity in the pilot injection S2 may be in a range of approximately 1-2 mg.

The pilot injection S2, also called as ignition injection or pre-injection, may inject a small amount of fuel before the main injection. By providing a short non-injection period before the main injection, the pilot injection S2 may help to improve air-fuel mixing and reduce noise and vibration of the diesel engine due to ignition delay of the main injection, contributing to combustion. Due to the pilot injection, the combustion pressure may moderately increase so that vibration and noise may be reduced, and the air-fuel mixing period may increase so that the emissions may be reduced.

The main injection S3 may be performed at the end of the compression stroke, and the fuel injector 15 may inject a predetermined main injection quantity of diesel fuel into the combustion chamber 4. For example, the main injection S3 may be performed in a range of a crank angle of 1.0° degree before top dead center (TDC) to a crank angle of 1.0° degree after TDC (i.e., 1.0° BTDC, −1.0° ATDC), and the main injection quantity in the main injection S3 may be approximately between 7.3 mg and 15.3 mg.

The post injection S4 may be performed after the main injection S3 and before the exhaust stroke, and the fuel injector 15 may inject a predetermined post injection quantity of diesel fuel into the combustion chamber 4. For example, the post injection S4 may be performed in a range of 300-400 μs after the end of the main injection, and the post injection quantity in the post injection S4 may be approximately between 1 mg and 2 mg. By performing the post injection S4 after the main injection S3, the liquid diesel fuel may be supplied to a catalytic converter, lowering the combustion temperature in the combustion chamber to reduce NO_{N}.

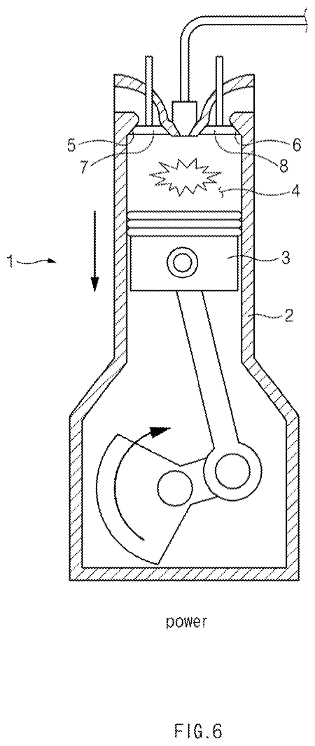

As illustrated in FIG. 6, the fuel injected in the main injection S3 may be atomized into small droplets and vaporized to form an air-fuel mixture. As the piston continues to rise and move closer to the cylinder head, the mixture temperature increases, causing auto-ignition (the power stroke). Here, as illustrated in FIG. 2, the diffusion combustion, in which the air-fuel mixing and combustion simultaneously occur, may take place until after the end of the post injection S4. The emissions may be produced as a byproduct of the diffusion combustion process. In the diffusion combustion process, heat may release as chemical energy of the fuel is converted into thermal energy. Then, in a process that converts it into mechanical energy, engine performance is calculated, and fuel consumption is calculated by the quantity of fuel consumed and the engine performance.

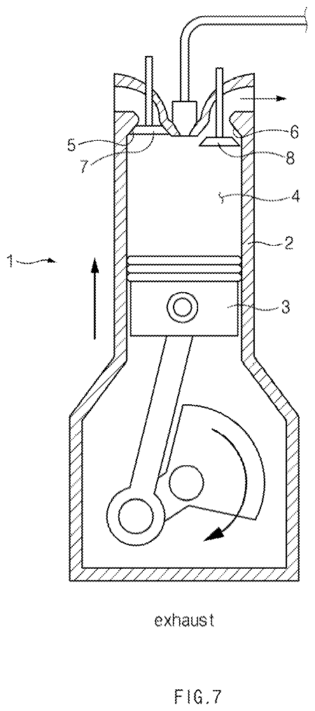

After the power stroke, as illustrated in FIG. 7, the exhaust valve 8 may open the exhaust port 6 so that the exhaust stroke in which the combustion gas is discharged through the exhaust port 6 may occur in operation S5.

As described above, the vaporized diesel fuel, together with the ambient air and EGR gas, may be introduced into the combustion chamber 4 during the intake stroke so that the vaporized diesel fuel may be premixed with the ambient air and EGR gas during the intake stroke, and thus the premixed combustion may take place until the start of the main injection S3. As the premixed combustion takes place before the main injection S3, the diffusion combustion after the main injection S3 may be relatively reduced so that soot formation may be reduced.

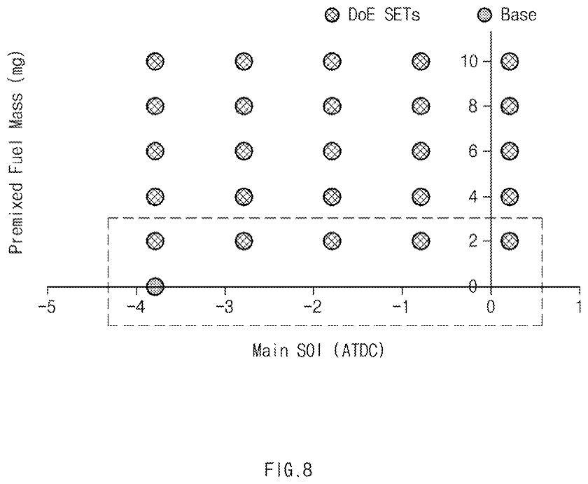

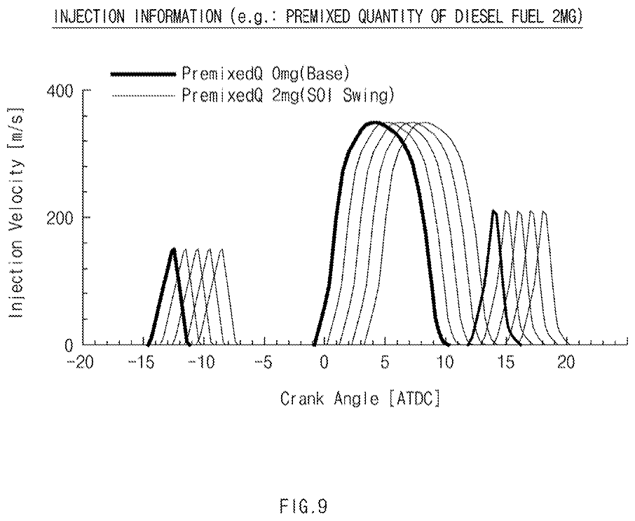

FIGS. 8 and 9 illustrate graphs of cases for design of experiments (DOE) analysis depending on the premixed quantity of diesel fuel, injection information, and the like. Here, the subject of analysis (or experiment) is a 2.0 L Euro 6 diesel engine, and the operating point to be examined is an engine speed of 2000 rpm, and a brake mean effective pressure (BMEP) is 6 bar. The premixed quantity of diesel engine is varied in a range of 0-10 mg, and the start of the main injection is varied from a crank angle of 3.8° degree before TDC to a crank angle of 0.2° degree before TDC (i.e., 3.8° BTDC-0.2° BTDC). The total fuel quantity to be supplied in one cycle of each cylinder is fixed, and when the premixed quantity of diesel engine is increased, the main injection quantity is reduced, and the pilot injection quantity and the post injection quantity are varied according to variations in main injection quantity.

FIG. 8 illustrates cases for DOE analysis with respect to the premixed quantity of diesel fuel for premixing of the diesel fuel, the ambient air, and EGR gas, and Start of Injection (SOI) which is a mapping control factor. Here, the cases include a base of which the premixed quantity of diesel fuel according to SOI is 0 mg, and a DOE set of which the premixed quantity of diesel fuel according to SOI is 2 mg, 4 mg, 6 mg, 8 mg, and 10 mg.

FIG. 9 illustrates a graph of injection velocity according to crank angle degrees in a case in which the premixed quantity of diesel fuel is 0 mg, and in a case in which the premixed quantity of diesel fuel is 2 mg.

Table 1 below indicates variations in main injection quantity in cases in which the premixed quantity of diesel fuel is 0 mg, 2 mg, 4 mg, 6 mg, 8 mg, and 10 mg.

TABLE 1

| | Case | | | | | |
|---|---|---|---|---|---|---|
| | 1(Base) | 2 | 3 | 4 | 5 | 6 |
| Total Fuel | 20.8 | | | | | |
| Quantity (mg) | | | | | | |
| Premixed Quantity | 0.0 | 2.0 | 4.0 | 6.0 | 8.0 | 10.0 |
| (mg) | | | | | | |
| Pilot Injection | 1.5 | | | | | |
| Quantity (mg) | | | | | | |
| Main Injection | 17.3 | 15.3 | 13.3 | 11.3 | 9.3 | 7.3 |
| Quantity (mg) | | | | | | |

| | |
|---|---|
| Post Injection | 2.0 |
| Quantity (mg) | |

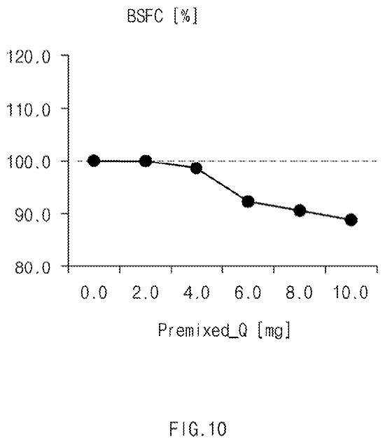

Referring to FIG. 10, it can be seen that brake specific fuel consumption (BSFC) is reduced when the premixed quantity of diesel fuel is greater than or equal to 4 mg (approximately 20% of the total fuel quantity).

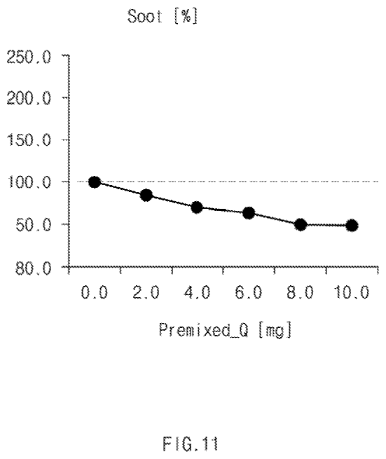

Referring to FIG. 11, it can be seen that soot formation is mitigated when the premixed quantity of diesel fuel is greater than or equal to 4 mg (approximately 20% of the total fuel quantity).

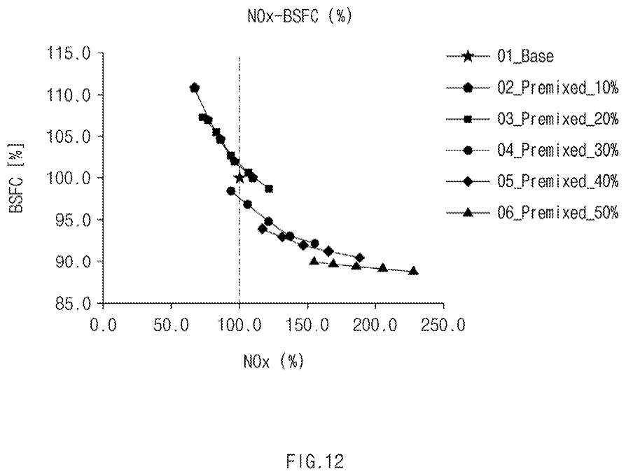

Referring to FIG. 12, it can be seen that a ratio of BSFC with respect to NOₓ production is significantly reduced in a case in which the premixed quantity of diesel fuel is 6 mg (approximately 30% of the total fuel quantity).

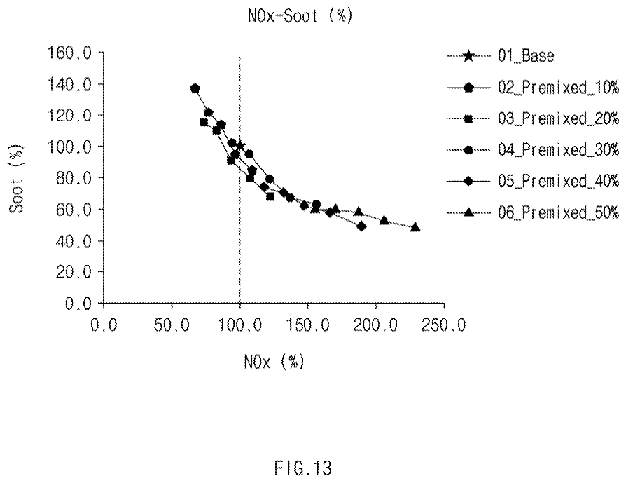

Referring to FIG. 13, it can be seen that a ratio of soot with respect to NOₓ production is significantly reduced in the case in which the premixed quantity of diesel fuel is 6 mg (approximately 30% of the total fuel quantity).

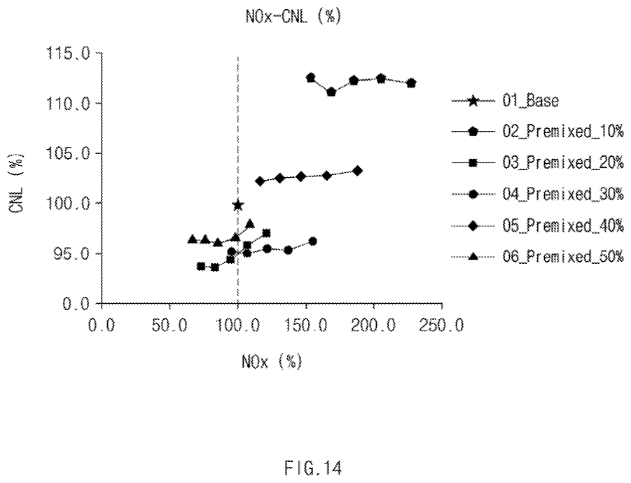

Referring to FIG. 14, it can be seen that a ratio of combustion noise level (CNL) with respect to NOₓ production is reduced in the case in which the premixed quantity of diesel fuel is 6 mg (approximately 30% of the total fuel quantity).

As indicated in table 2 below, in the case in which the premixed quantity of diesel fuel is 6 mg (approximately 30% of the total fuel quantity), BSFC is improved by approximately 3%, and CNL is improved by approximately 5%. In particular, when the diesel fuel premixed ratio (the premixed quantity of diesel fuel/the total fuel quantity) is 30%, and the start of main injection occurs at a crank angle of 0.3° degree before TDC (0.3° BTDC), an optimum effect may be achieved.

TABLE 2

| | | Diesel Fuel Premixed | | | | | |
|---|---|---|---|---|---|---|---|
| Premixed | | Ratio (Premixed | | | | | |
| Quantity of | | Quantity/Total | Start of | | | | |
| Diesel Fuel | | Fuel Quantity) | Main Injection | BSFC | NOₓ | Soot | CNL |
| 2-4 | mg | 10%-20% | 2.3 before TDC | deteriorated | — | improved | improved |
| 6 | mg | 30% | 0.3 before TDC | improved | — | — | improved |
| 8-10 | mg | 40%-50% | 0.2 after TDC | improved | deteriorated | improved | deteriorated |

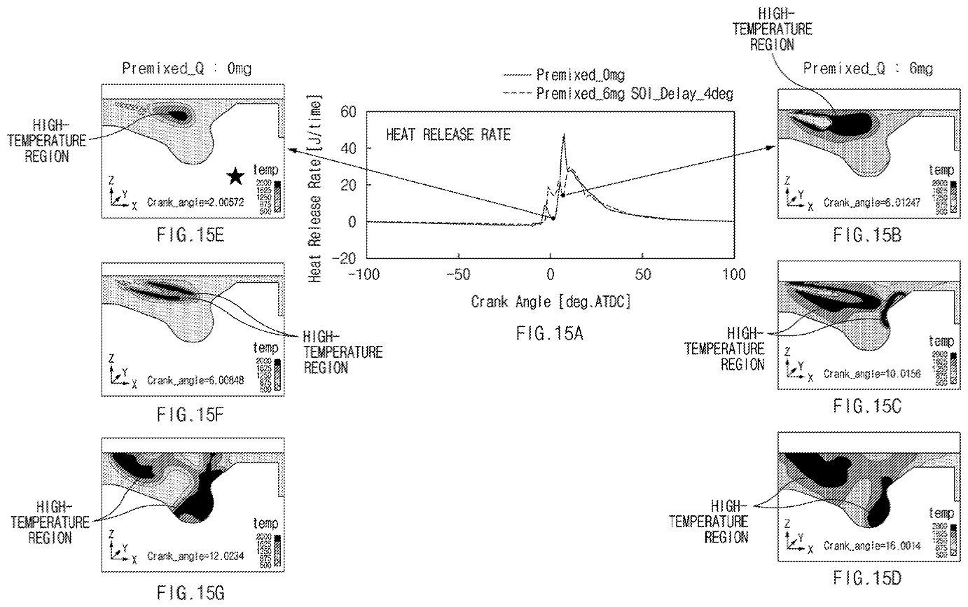

Referring to FIG. 15A and FIGS. 15E to 15G, in a case in which the premixed quantity of diesel fuel is 0 mg, as the crank angle degree increases at the end of the compression stroke, the heat release rate may increase sharply, and thus BSFC may be reduced. In comparison, in the case in which the premixed quantity of diesel fuel is 6 mg (approximately 30% of the total fuel quantity with reference to FIG. 15A and FIGS. 15B-15D), the diesel fuel is premixed with the ambient air and EGR gas during the intake stroke, and as the crank angle degree increases, the heat release rate may be gradually increased by the pilot injection S2, and the combustion may be strengthened by the main injection S3, and thus combustion efficiency and BSFC may be improved.

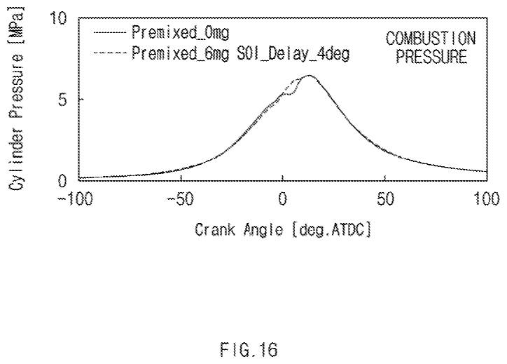

Referring to FIG. 16, in the case in which the premixed quantity of diesel fuel is 0 mg, as the crank angle degree increases at the end of the compression stroke, the combustion pressure may increase sharply, and thus CNL may be deteriorated. In comparison, in the case in which the premixed quantity of diesel fuel is 6 mg (approximately 30% of the total fuel quantity), the diesel fuel is premixed with the ambient air and EGR gas during the intake stroke, and as the crank angle degree increases, the combustion pressure may be gradually increased by the pilot injection S2, and thus CNL may be improved.

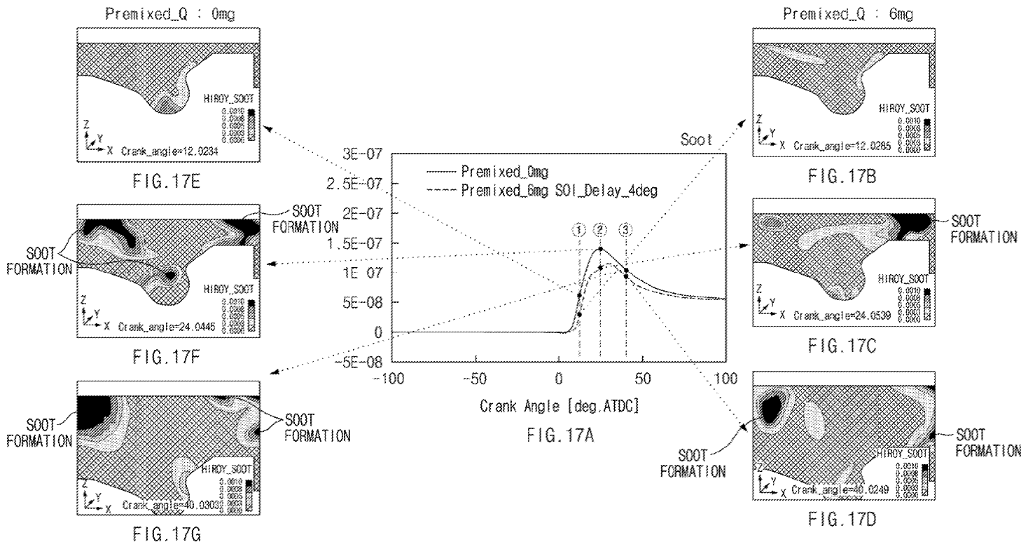

Referring to FIG. 17A and FIGS. 17E to 17G, in the case in which the premixed quantity of diesel fuel is 0 mg, the main injection quantity is relatively increased, and thus the soot formation resulting from the incomplete combustion may be increased. In comparison, in the case in which the premixed quantity of diesel fuel is 6 mg (approximately 30% of the total fuel quantity with reference to FIG. 17A and FIGS. 17B to 17D), the main injection quantity is relatively reduced, and thus the soot formation may be reduced.

As set forth above, according to exemplary forms of the present disclosure, the premixed combustion and the diffusion combustion may take place simultaneously, thereby improving fuel efficiency, reducing combustion noise, and significantly reducing emissions.

In addition, according to exemplary forms of the present disclosure, as the vaporized diesel fuel is premixed with the ambient air and EGR gas in the intake stroke, the premixed combustion may take place before the start of the main injection, and the diffusion combustion may be relatively reduced after the main injection, thereby reducing soot formation.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. A method for controlling combustion in a diesel engine, the method comprising:
premixing ambient air, exhaust gas recirculation (EGR) gas, and vaporized diesel fuel in a combustion chamber of the diesel engine during an intake stroke of each cylinder of the diesel engine; and
sequentially performing, by an injector, pilot injection, main injection, and post injection during a compression stroke which occurs after the intake stroke.

2. The method according to claim 1, wherein the main injection is performed at an end of the compression stroke.

3. The method according to claim 1, wherein the main injection is performed in a range from approximately 1.0° degree before top dead center (BTDC) to 1.0° degree after top dead center (ATDC).

4. The method according to claim 1, wherein a premixed quantity of diesel fuel introduced into the combustion chamber during the intake stroke accounts for approximately from 25% to 35% of a total fuel quantity which is supplied per cycle of each cylinder.

5. The method according to claim 1, wherein a premixed quantity of diesel fuel introduced into the combustion chamber during the intake stroke accounts for approximately 30% of a total fuel quantity which is supplied per cycle of each cylinder.

6. The method according to claim 1, wherein the pilot injection is performed in a range from approximately 1100 μs to 1200 μs before starting the main injection, and
a pilot injection quantity in the pilot injection is from approximately 1 mg to 2 mg.

7. The method according to claim 1, wherein the post injection is performed in a range from 300 μs to 400 μs after the main injection ends, and
a post injection quantity in the post injection is approximately between 1 mg and 2 mg.
